(19) United States
(12) Patent Application Publication
(10) Pub. No.: US 2025/0055408 A1
(43) Pub. Date: Feb. 13, 2025

(54) SKIP MOUNT INSTALLATION SYSTEM

(71) Applicant: Pegasus Solar, Inc., Richmond, CA (US)

(72) Inventor: Erich Kai Stephan, Richmond, CA (US)

(21) Appl. No.: 18/797,483

(22) Filed: Aug. 7, 2024

Related U.S. Application Data
(60) Provisional application No. 63/531,294, filed on Aug. 7, 2023.

(51) Int. Cl. H02S 20/23

(52) U.S. Cl. CPC H02S 20/23

(57) ABSTRACT

Systems and methods for mounting solar modules are disclosed herein. A mounting system for solar modules includes a first-row solar module and a second-row solar module having a bottom edge and a top edge opposite the bottom edge, a structural clamp configured to connect the top edge of the first-row solar module to a bottom edge of a second-row solar module, roof attachments configured to secure the first-row solar module and the second-row solar module, and structural clamps that connect the first-row solar module to the second-row solar module. The mounting system for solar modules may be installed by installing a first row of roof attachments to a roof surface using fasteners, installing a second row of roof attachments to a roof surface using fasteners, and installing a third row of roof attachments to a roof surface using fasteners.

### CROSS-REFERENCE TO RELATED APPLICATION

The present application is a continuation and claims the priority benefit of provisional U.S. patent application 63/531,294 filed Aug. 7, 2023, the disclosure of which is incorporated herein by reference.

### BACKGROUND OF THE CLAIMED INVENTION

### 1. Field of the Disclosure

The present patent application relates to mount installation systems. More specifically, the present patent application relates to skip mount installation systems.

### 2. Description of the Related Art

Currently, solar modules are typically installed onto a series of beams, often called rails. The solar modules may be arranged in an array with columns and rows. The rows of solar modules may not connect to one another. The present invention demonstrates a system to replace the rails with roof mounts and remove rows of roof mounts by structurally connecting rows of solar modules together using a module-to-module clamp.

### SUMMARY OF THE CLAIMED INVENTION

A system and a method for mounting solar modules are disclosed herein. A mounting system for solar modules includes a first-row solar module having a bottom edge and a top edge opposite the bottom edge, a second-row solar module having a bottom edge and a top edge opposite the bottom edge, a structural clamp configured to connect the top edge of the first-row solar module to a bottom edge of a second-row solar module, four roof attachments configured to secure the first-row solar module, two roof attachments in a third row of roof attachments configured to secure a second-row solar module, and two structural clamps that connect the first-row solar module to the second-row solar module.

The method for installing mounting system for solar modules includes installing a first row of roof attachments to a roof surface using fasteners, installing a second row of roof attachments to a roof surface using fasteners, the second row of roof attachments positioned up-roof from a first row of roof attachments a distance less than the up-roof length of a to-be-installed first row of solar modules; and installing a third row of roof attachments to a roof surface using fasteners, the third row of roof attachments positioned up-roof from a second row of roof attachments a distance equal to the up-roof length of a to-be-installed second row of solar modules plus or minus 10 inches.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1 depicts a top-down view representing an example embodiment of the present invention.

FIG. 2 is an isometric view depicting an example embodiment of the present invention.

FIGS. 3A-3E depict isometric and top-down views of the present invention with an example sequence of installation.

FIGS. 4A-4B depict side and isometric views of the left side of an installed array of solar modules 200 representing one example embodiment of the present invention.

FIGS. 5A-5B depict side and isometric views of an example embodiment of the present invention.

FIG. 6 depicts an isometric view of a foot representing an example embodiment of the present invention.

FIG. 7 depicts an isometric view of attachment bracket.

FIG. 8 depicts a top-down view of attachment bracket.

FIG. 9 depicts an end-view of attachment bracket.

FIG. 10 depicts an underside view of attachment bracket.

FIG. 11 depicts an isometric view of attachment bracket installed on a roof surface.

FIG. 12A and 12B depict end and side views of attachment brackets with a module clamp.

FIG. 13 depicts an isometric view of a shorter attachment brackets.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

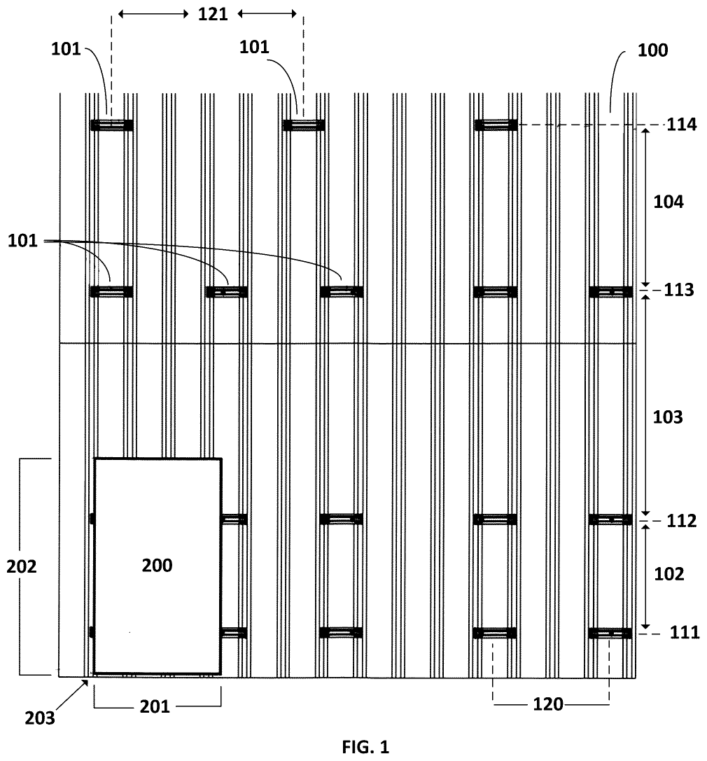

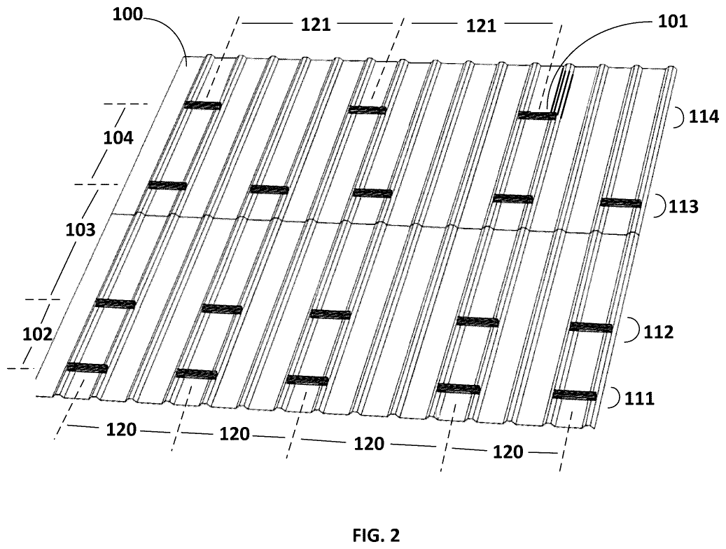

FIG. 1 depicts a top-down view of the present invention representing one example embodiment. FIG. 2 is an isometric view of the same, providing another perspective for ease of understanding. Roof surface 100 may be a metal roof, such as a standing-seam, R-module, trapezoidal module, corrugated steel or tin; or roof surface 100 may be a composition or asphalt shingle, or roof surface 100 may be a concrete or clay tile roof, or roof surface 100 may be concrete, foam, TPO, PVC, wood shake, or any suitable roofing material. A plurality of attachment brackets attachment brackets 101 are disposed on roof surface 100 in a series of rows and columns according to the eventual layout and orientation of solar modules 200 that may be installed on the plurality of attachment brackets attachment brackets 101. Solar modules 200 may also be called a solar panel. Solar module 200 may have a module width module width 201 and module length 202. Solar modules 200 may be oriented in either portrait or landscape orientation on roof surface 100, where a portrait orientation would have module length module length 202 arranged up the slope of the roof (between the gutter line and the ridge), and a landscape orientation would have module width module width 201 arranged up the slope of the roof (between the gutter line and the ridge). In some example embodiments, the solar modules may be solar photovoltaic modules, with a maximum voltage output less than or equal to 50 Volts and may have a rating of 300 to 800 Watts of output at Standard Test Conditions. Solar energy modules may be wired together in electrical series, or they may each connect to an electrical inverter than converts the electricity produced from direct current into alternating current. The electrical inverter may mounted onto each solar panel 200, or may be mounted to a roof attachment 101 at each solar panel 200.

In the example shown, attachment brackets attachment brackets 101 are arranged in a first attachment row first attachment row 111, a second attachment row second attachment row 111, a third attachment row third attachment row 111 and a fourth attachment row fourth attachment row 111. In this example, the attachment brackets attachment brackets 101 in the first attachment row first attachment row 111, second attachment row second attachment row 111, and third attachment row third attachment row 111 are spaced apart a portrait spacing 120, while the attachment brackets attachment brackets 101 in fourth attachment row fourth attachment row 111 are spaced apart a landscape spacing landscape spacing 121. Portrait spacing 120 is a distance such that a portion of each of a pair of attachment brackets attachment brackets 101 may be positioned under opposite sides of a solar module 200 in portrait orientation within a row (e.g. within first attachment row first attachment row 111). Similarly, landscape spacing 121 is a distance such that a portion of each of a pair of attachment brackets attachment brackets 101 may be positioned under opposite sides of a solar module 200 in landscape orientation within a row, such as within fourth attachment row fourth attachment row 111. In this example embodiment, first attachment row first attachment row 111 and second attachment row second attachment row 111 are spaced up-roof a first attachment row distance 102. Second attachment row second attachment row 111 and third attachment row third attachment row 111 are spaced up-roof a second attachment row distance 103. Third attachment row third attachment row 111 and fourth attachment row fourth attachment row 111 are spaced up-roof a third attachment row distance third attachment row distance 104.

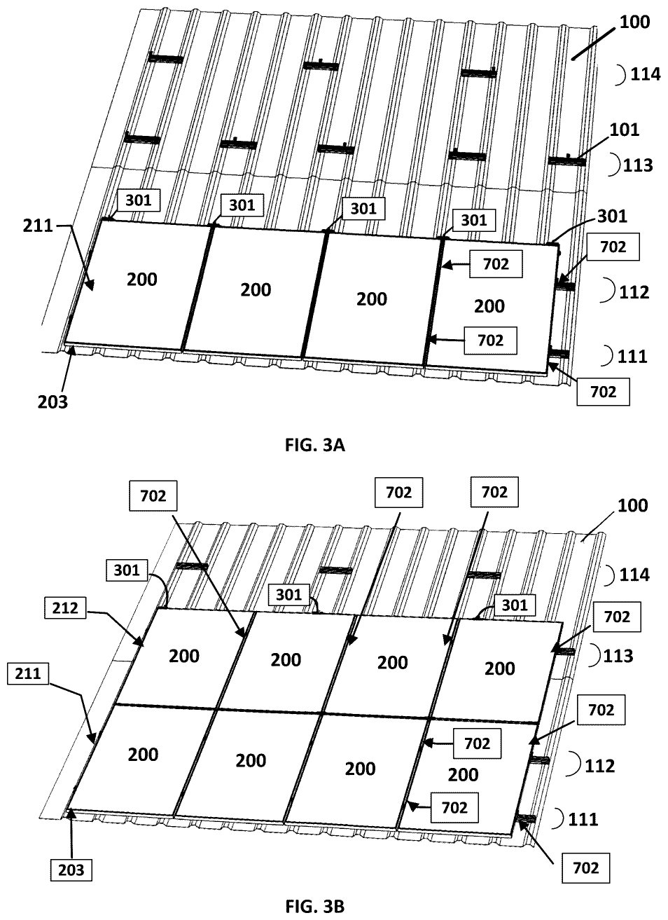

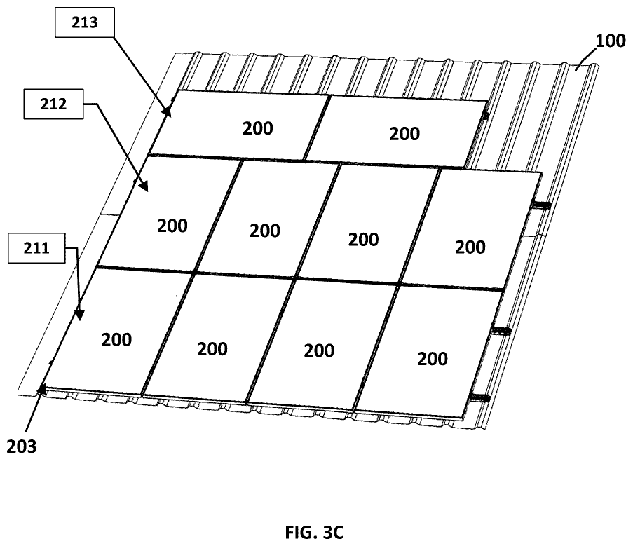

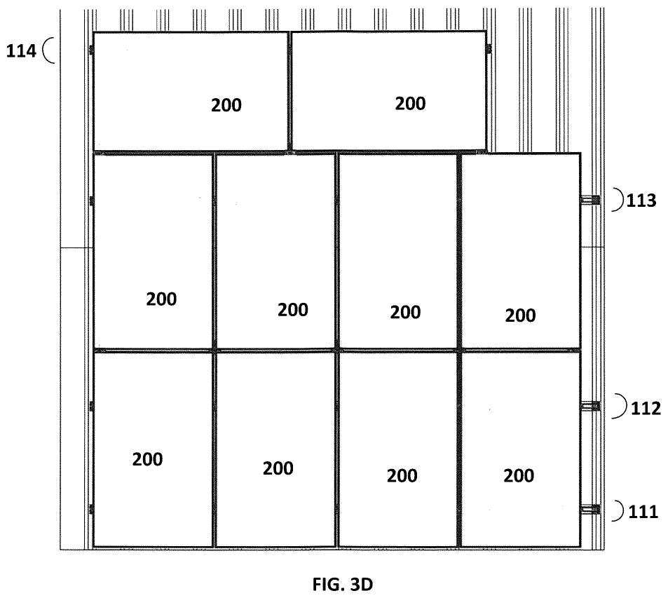

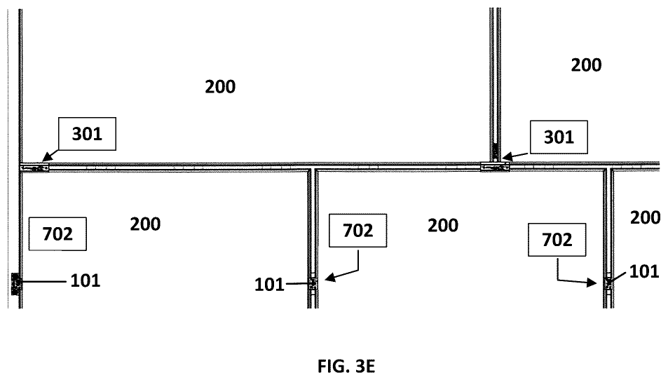

As depicted in FIG. 3A, in this example embodiment there the first row of solar modules 200 are in a portrait orientation, the first attachment row distance 102 is a distance less than module length 202. In other words, the distance from a first row of roof attachments 111 to a second row of roof attachments 112 is less than the up-roof length of a first row of solar modules 211. In an example embodiment not shown where the first row of solar modules 200 are in a landscape orientation, the first attachment row distance 102 is a distance less than module width 201. In other words, whether the first row of solar modules 200 is in either portrait or landscape orientation, the first attachment row 111 and second attachment row 111 will be positioned under the solar modules 200 when viewed along the axis from the bottom edge to the top edge of roof surface 100. The attachment brackets attachment brackets 101 may protrude out the left and right sides of the solar modules 200 as shown on the left side of FIG. 1.

As depicted in FIG. 3B, in this example embodiment the second row of solar modules 200 are also in a portrait orientation, and the second attachment row distance 103 is a distance equal to module length 202 plus or minus 10 inches. In an example embodiment not shown where the second row of solar modules 200 are in a landscape orientation, the second attachment row distance 103 would be a distance equal to module width 201 plus or minus 10 inches. As depicted in FIG. 3C, in this example embodiment the third row of solar modules 200 are in landscape orientation, and the third attachment row distance 104 is a distance equal to module width 201 plus or minus 10 inches. In an example embodiment not shown where the third row of solar modules 200 are in a portrait orientation, the third attachment row distance 104 would be a distance equal to module length 202 plus or minus 10 inches.

The spacings of attachment rows may thus follow a rule for N-number of rows of solar modules 200, first attachment row distance 102 is less than module length 202 for solar modules 200 in portrait orientation or less than module width 201 for solar modules 200 in landscape orientation. For one or more subsequent rows of solar modules 200 positioned above the first row of solar modules 200, the up-roof attachment spacing (e.g. second attachment row distance 103, third attachment row distance 104, etc.) is equal to module length 202 plus or minus 10 inches for solar modules 200 in portrait orientation or equal to module width 201 plus or minus 10 inches for solar modules 200 in landscape orientation.

An alternative configuration for attaching a roof attachment to solar module 200 in portrait orientation may include positioning a first attachment row 111 within a first half of solar module 200 between the bottom module row edge 203 of solar module 200 and up to half of module length 202 (and a second attachment row may be positioned within a second half of solar module 200 between the top module row edge and the half of module length 202). For solar modules 200 in landscape orientation first attachment row 111 may be positioned a distance between coincident to bottom module row edge 203 and up to half of module width 201. Second attachment row 112 may be positioned a distance from bottom module row edge 203 between half module length 202 to full module length 202 for solar modules 200 in portrait orientation and between half module width 201 to full module width 201 for solar modules 200 in landscape orientation. Third attachment row 111 may be a distance second attachment row distance 103 such that third attachment row 111 is positioned up-roof from the bottom edge of 212 to between half module length 202 full module length 202 for solar modules 200 in portrait orientation and to between half module width 201 to full module width 201 for solar modules 200 in landscape orientation. Fourth attachment row 111 may be a distance from third attachment row distance 104 such that fourth attachment row 111 is positioned up-roof from the bottom edge of 213 to half module length 202 to full module length 202 for solar modules 200 in portrait orientation and between half module width 201 to full module width 201 for solar modules 200 in landscape orientation.

FIGS. 3A-3E depict an isometric view of an example sequence of installation representing an example embodiment and method of the present invention. In a potential first step, the location of the solar modules 200 may be marked on roof surface 100, such as by marking the approximate corner locations of each solar module 200 with a chalk or crayon. In a potential next step, the attachment brackets attachment brackets 101 are installed on roof surface 100 in a pattern to align under the eventual placement of solar modules 200 using the guidelines for distances first attachment row distance 102, second attachment row distance 103, and third attachment row distance 104 as previously described. In an alternative next step, only the first attachment row 111 and second attachment row 111 are installed. In a potential next step, a first solar module 200 is installed on four attachment brackets attachment brackets 101—two attachment brackets attachment brackets 101 in first attachment row 111 and two attachment brackets attachment brackets 101 in second attachment row 111. Additional solar modules 200 are then installed in first solar module row 211 until first solar module row 211 is complete. The solar modules 200 in first solar module row 211 may be secured to the attachment brackets attachment brackets 101 using a module clamp module clamp 702. As a potential next step, a plurality of structural clamps 301 may be installed on an up-roof edge of solar modules 200 as shown in FIG. 3A. Structural clamps 301 may be installed to align with the up-roof edges of a to-be-installed next row of solar modules 200. For example, as shown in FIG. 3A, a structural clamp 301 is installed to align with the outer edges of the solar modules 200 on either side of second solar module row 212, and structural clamps 301 are installed in mid-row locations to secure two solar modules 200 in the in the middle of a to-be-installed second solar module row 212. Module clamps 702 may be installed into roof attachment 101 before or after any solar modules 200 are installed. Module clamps 702 may be configured to secure one solar module 200 to a roof attachment 101 or two adjacent solar modules 200 in a row to a roof attachment 101.

As a potential next step, a second row of solar modules 212 may be installed, where the down-roof edge of a solar module 200 in second solar module row 212 is placed into the up-roof sides of a pair of structural clamps 301 and onto a pair of roof attachments 101 in a third attachment row 113. Structural clamps 301 connecting a first solar module row 211 and second solar module row 212 and module clamps 701 may be tightened before or after each successive solar module 200 in second solar module row 200 is installed.

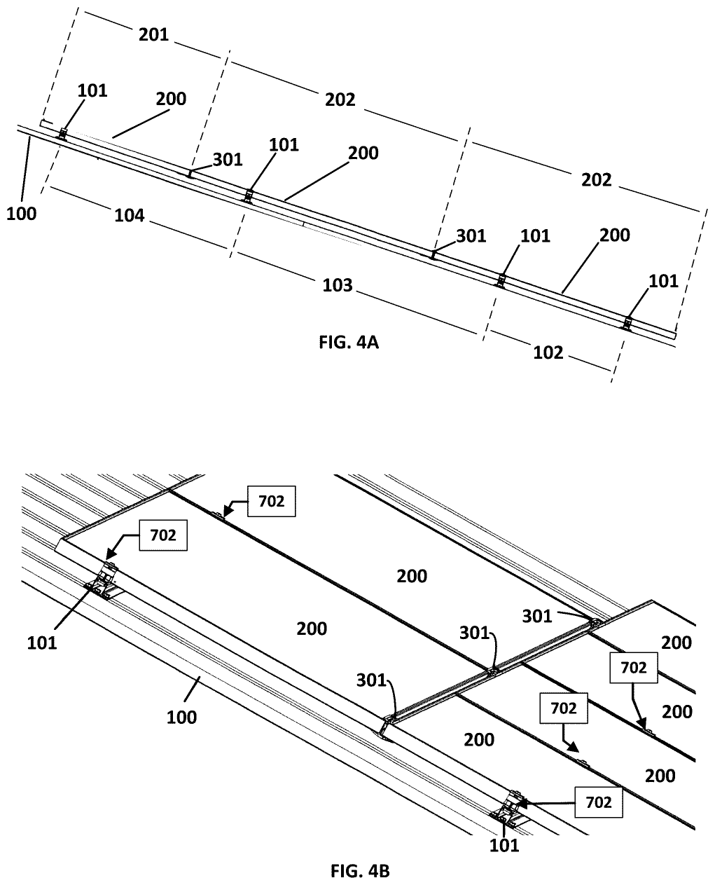

As a potential next step, structural clamps 301 may be installed on the top edge of second solar module row 212 in positions to along the upper edge of second solar module row 212 to align with up-roof edges of the to-be-installed solar modules 200 in third solar module row 213 (seen in FIG. 3C and FIG. 4B). In this example, since the solar module 200 in third solar module row 213 are in landscape orientation, the spacing of the structural clamps 301 on the top edge of second solar module row 212 are farther apart than the spacing of the structural clamps 301 on the top edge of first solar module row 211. In some cases, the structural clamps 301 on outer edges of second solar module row 212 or third solar module row 213 or any row of solar module 200 may be coincident with the outside up-roof edge of the applicable solar module 200, or the structural clamps 301 may be inset a desired distance, such as 1-2 inches, as shown in FIG. 4B. As a potential next step, as shown in FIG. 3C, a third solar module row 213 is installed into the up-roof sides structural clamps 301 and secured to the attachment brackets 101 using module clamps 701 in fourth attachment row 111.

As a potential guideline, in a given row of structural clamps 301, the spacing between interior structural clamps 301 will be substantially equal to module width 201 when the solar modules 200 in the above-row are in portrait orientation, or the spacing between interior structural clamps 301 will be substantially equal to module length 202 when the solar modules 200 in the above-row are in landscape orientation, and a structural clamps 301 will be located approximately coincident with the outer up-roof edge of the solar module 200 on either end of a row of solar modules 200.

Structural clamp 301 may have one or more electrical bond features configured to pierce a coating on a solar module, such as an anodization or paint or powder coated surface, and create an electrical bond path between two or more solar modules 200 engage with the structural clamp 301. In some cases, structural clamp may electrically bond only a first solar module 200 in a row below and a first solar module 200 in a row above.

FIG. 4A and 4B depict side and isometric views of the left side of an installed array of solar modules 200 representing one example embodiment of the present invention. In this example embodiment, structural clamps 301 are not connected nor touching roof surface 100. Structural clamps 301 provide a structural connection between rows of solar modules 200, such as between first solar module row 211 and second solar module row 212, or between second solar module row 212 and third solar module row 213. As previously described, attachment brackets attachment brackets 101 may be secured to roof surface 100 by one or more fasteners or adhesives.

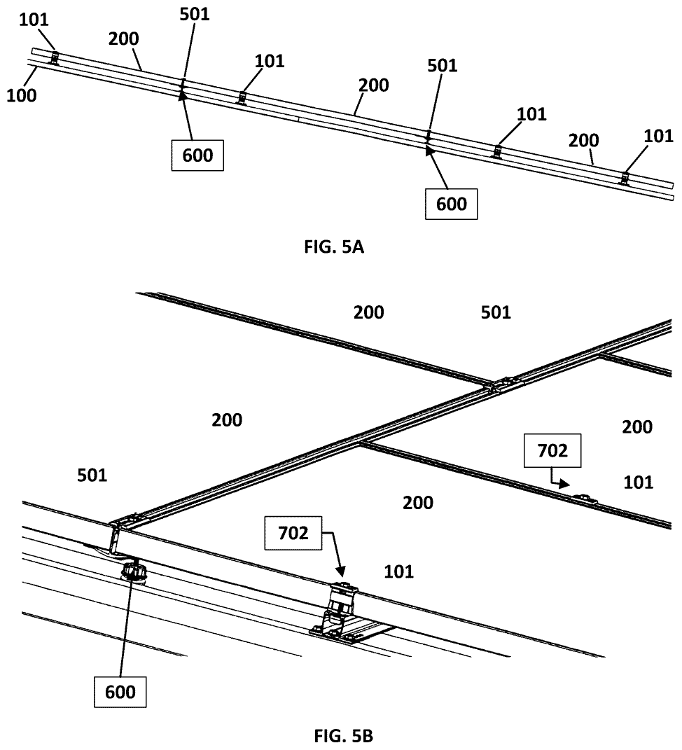

FIG. 5A and 5B depict side and isometric views of the left side of an installed array of solar modules 200 where the structural clamps with foot structural clamps with foot 501 are used instead of structural clamps 301 representing an alternative example embodiment of the present invention. In this example embodiment, foot 600 may be in a retracted position so as not to interfere with roof surface 100 when structural clamps with foot 501 are being installed on a solar module 200. Once structural clamps with foot 501 are installed on a solar module 200 in a manner described previously and shown in FIGS. 3A-3E, then foot 600 may be lowered to be coincident with a 100. Foot 600 may be lowered after structural clamp with foot 501 is installed onto a solar module 200, but before a next row of solar modules 200 is installed. In other example embodiments, foot 600 may be accessible between the edges of adjacent solar modules 200, allowing for height adjustment of foot 600 after solar modules 200 are installed in both clamping sides of the structural clamps with foot 501 (i.e. after up to four solar modules 200 are installed into a structural clamp with foot 501). Foot 600 may threadably engage with a structural clamp with foot 501 to provide height adjustment of the structural clamp with foot 501 relative to roof surface 100.

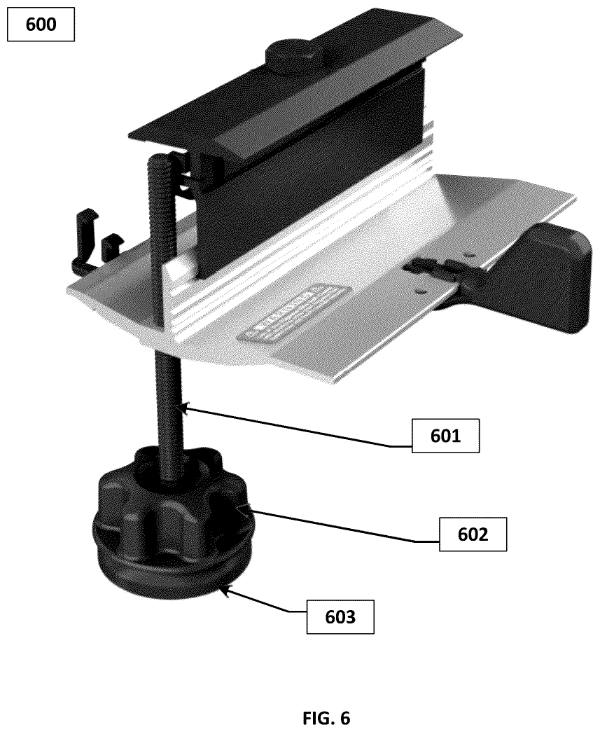

FIG. 6 depicts an isometric view of foot 600 representing one example embodiment of the present invention. Foot 600 may consist of a threaded body 601, a knob 602, and a foot plate 603. Foot plate 603 may articulate relative to the primary axis of the threaded body in order to compensate for undulations, unevenness, or debris on roof surface 100. In an example method, once the structural clamp with foot 501 is installed onto a first solar module 200, knob 602 may be rotated in order to rotate threaded body 601, thereby lowering foot 600 so foot plate 603 abuts roof surface 100. As a potential next step, a second solar module 200 is installed on the up-slope side of the structural clamps with foot 501. Foot 600 may be designed to provide sufficient structural support to prevent the solar module 200 from substantially flexing toward roof surface 100 when a load is applied to the top of one or more solar modules 200, such as from a person walking on the solar module 200, or snow accumulating on solar module 200, or the force of wind pushing down on the top surface of solar module 200.

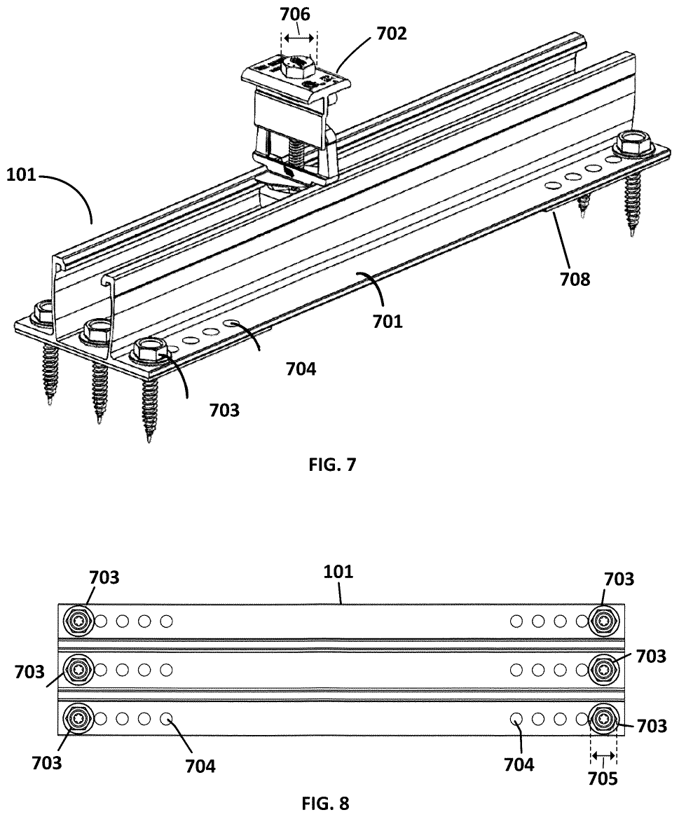

FIG. 7 depicts an isometric view of attachment bracket 101 representing one example embodiment of the present invention. Mount 701 may have one or more mount apertures 704 disposed on a bottom surface, configured to receive one or more roof fasteners 703. A moisture barrier or sealing layer 708 may be disposed on the underside of mount 701 and covering all or most of the one or more mount apertures 704. A module clamp module clamp 702 may be demountably engaged to a channel, groove, flange, rib, or similar feature on mount 701. Module clamp module clamp 702 may have a module clamp fastener with a hex head 706 for engaging with a tool. Hex head 706 may have a width of approximately 0.5 inches across as drawn.

FIG. 8 depicts a top-down view of attachment bracket 101. As depicted, roof fastener 703 has a hexagonal head with a hex head width 705. Hex head 706 and hex head width 705 may have substantially the same size and shape such that the exact same tool, such as a 0.5 inch socket driver, can be used to engage each fastener.

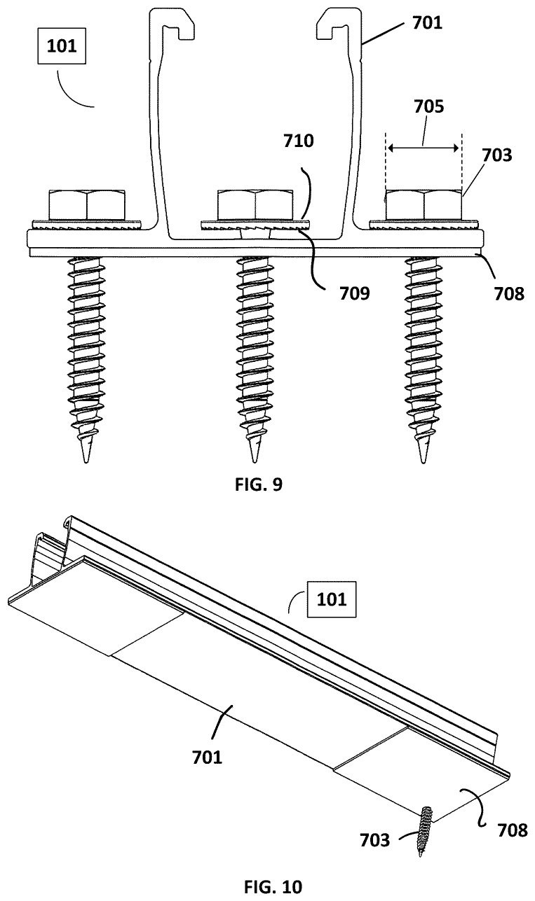

FIG. 9 depicts an end-view of attachment bracket 101.

FIG. 10 depicts and underside view of attachment bracket 101, demonstrating scaling layer 708 disposed on the underside. Sealing layer 708 may be configured to form a watertight seal between the roof attachment 101 and roof surface 100 when the roof attachment 101 is installed. Scaling layer 708 may be a butyl mastic, butyl tape, bonded EPDM foam and butyl tape, EPDM foam, EPDM rubber, rubber, a non-skinning and/or non-hardening butyl compound, or similar suitable material. Sealing layer 708 may partially cover the underside of attachment brackets 101, as depicted, or may fully cover the underside of attachment brackets 101. When installed, roof fastener 703 may be configured to pierce through sealing layer 708 in order to reach an installation surface.

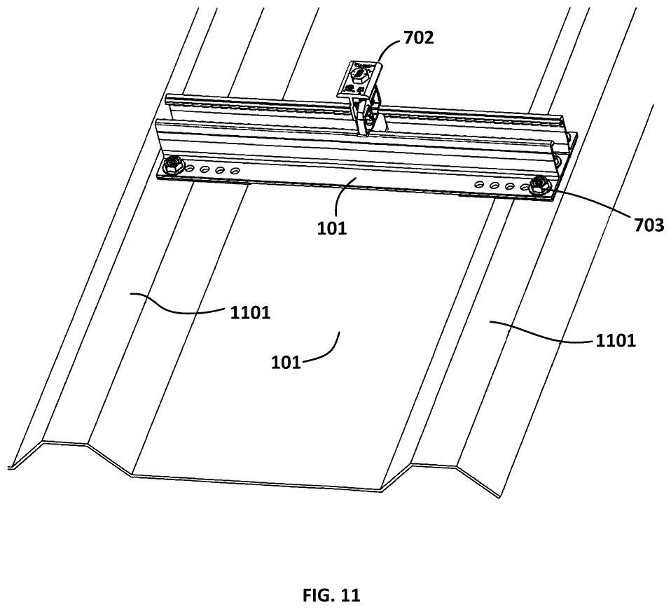

FIG. 11 depicts an isometric view of attachment bracket 101 installed on a roof surface 100 that has one or more roof ribs 1101, representing an example embodiment of the present invention. In this example, roof surface 100 and roof ribs 1101 may be a metal roof, such as a R-module, trapezoidal, standing scam, corrugated, wave, or similar roofing configuration. Attachment brackets 101 may be affixed to crest or top portion roof ribs 1101 using one or more roof fasteners 703. In this example embodiment, the roof fastener 703 may be configured to cut into and threadably engage the material of roof surface 100 to create a mechanical connection between the attachment bracket 101 and the roof surface 100. Attachment brackets 101 may have a distance sufficient to span or bridge between two or more roof ribs 1101 as depicted, and a series of mount apertures 704 disposed on the attachment brackets 101 may be sufficiently spaced apart to enable one or more roof fasteners 703 to secure into the crest of two laterally displaced roof ribs 1101.

In an example installation method of attachment brackets 101 onto roof surface 100, a protective liner may be removed from one or more sealing layers 708. Attachment brackets 101 may be placed to span across two roof ribs 1101 such that at least one set of mount apertures 704 on either end of the attachment bracket 101 substantially aligns with the crest of a roof rib 1101. Then one or more roof fasteners 703 may be installed through a respective one or more mount apertures 704 and into a roof ribs 1101. A module clamp 702 may be installed into attachment bracket 101. A first solar module 200 may be placed on to attachment brackets 101, then module clamps 702 slid along the length of attachment brackets 101 to engage with a first solar module 200. Then a second solar module 200 may be placed onto attachment brackets 101 and slid to engage a second side of a module clamp 702. Then module clamp 702 may be tightened.

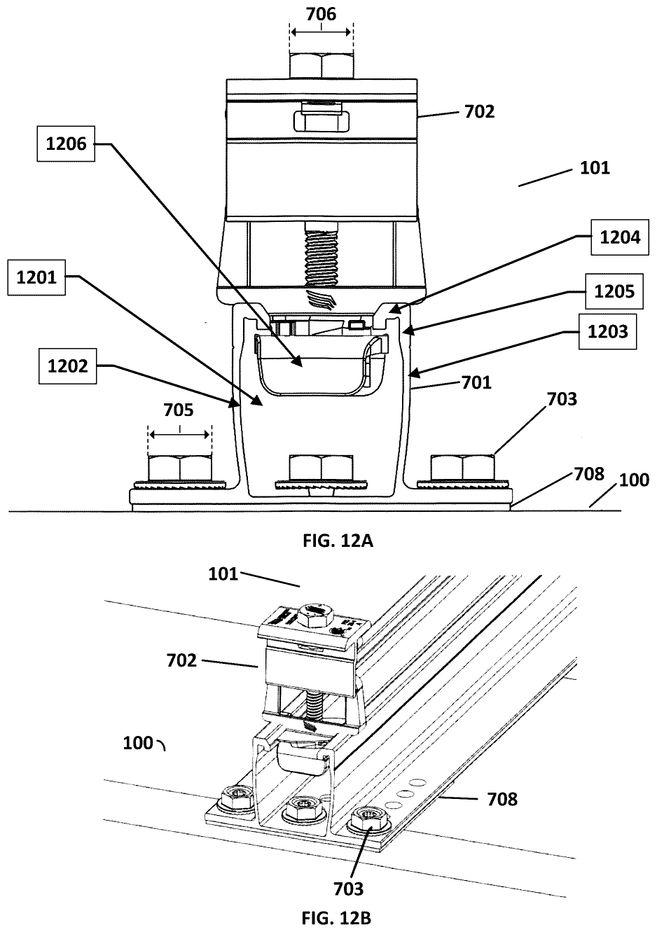

FIG. 12A and 12B depict end and side views of attachment brackets 101 with a module clamp 702, representing an example embodiment of the present invention. As depicted, channel 1201 may extend the length of attachment brackets 101. Channel 1201 may be formed by two walls 1202, each wall 1202 may have a thicker cross-sectional area 1205 near the distal end of the wall 1202 away from a roof surface 100 as compared thin cross-section area 1203 that is closer to roof surface 100. One or more lateral flanges 1204 may extend laterally from the distal ends of the walls 1202 and configured to engage with a nut 1206 on the underside of a module clamp 702.

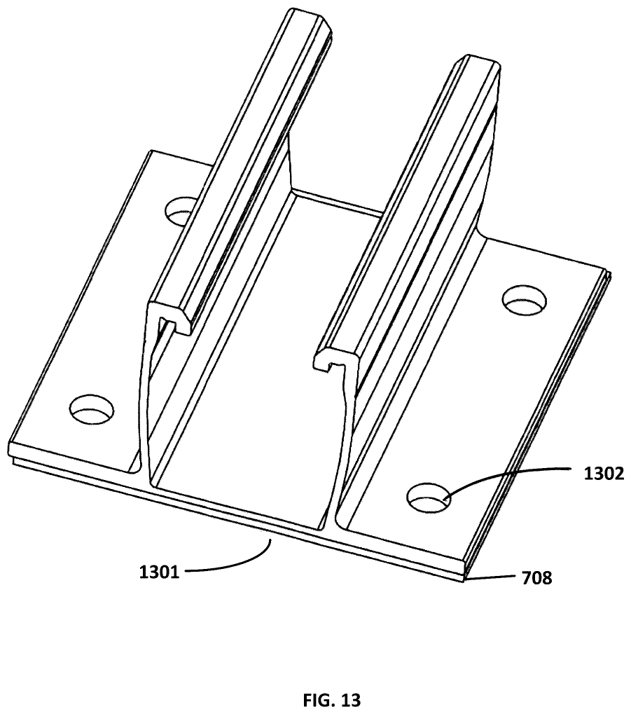

FIG. 13 depicts an isometric view of a shorter attachment brackets 101, representing an example embodiment of the present invention. In this example, the attachment bracket 101 may have fewer mount apertures 704 than previously described, and may be configured to install on a composite asphalt shingle roof surface, rolled asphalt roof, metal roof, or similar common roofing application.

What is claimed is:

1. A mounting system for solar modules, the system comprising:
a first-row solar module having a bottom edge and a top edge opposite the bottom edge of the first-row solar module;
a second-row solar module having a bottom edge and a top edge opposite the bottom edge of the second-row solar module;
a structural clamp configured to connect the top edge of the first-row solar module to the bottom edge of the second-row solar module;
a first row of one or more roof attachments positioned within a first half of the first-row solar module between the bottom edge of the first-row solar module and half of an up-roof length of the first-row solar module;
a second row of one or more roof attachments positioned within a second half of the first-row solar module between the top edge of the first-row solar module and the half of the up-roof length of the first-row solar module;
a third row of one or more roof attachments configured to secure the second-row solar module, wherein the third row of roof attachments is positioned between the top edge of the second-row solar module and half of the up-roof length of the second-row solar module; and
two structural clamps that connect the first-row solar module to the second-row solar module, wherein the two structural clamps are positioned between the second row of roof attachments and the third row of roof attachments.

2. The mounting system of claim 1, wherein the roof attachments of one or more of the first row, the second row, and the third row are attached to a roof surface using one or more fasteners.

3. The mounting system of claim 1, further comprising one or more module clamps configured to attach the first-row solar module to the first row of roof attachments.

4. The mounting system of claim 1, wherein the structural clamp includes an up-roof side configured to connect two solar modules in the second row of solar modules.

5. The mounting system of claim 1, wherein solar modules in a first row are in portrait orientation and solar modules in a second row of solar modules are in portrait orientation.

6. The mounting system of claim 1, wherein solar modules in a first row of solar modules are in portrait orientation, and wherein solar modules in a second row of solar modules are in landscape orientation.

7. The mounting system of claim 1, wherein solar modules in a first row of solar modules are in landscape orientation and solar modules in a second row of solar modules are in landscape orientation.

8. The mounting system of claim 1, wherein a distance from the first attachment row to the second attachment row is less than the up-roof module length.

9. The mounting system of claim 1, wherein the solar modules are solar photovoltaic modules that produce between 300 and 800 Watts of electricity.

10. The mounting system of claim 1, wherein the structural clamps provide an electrical bond path from a first row of solar modules to a second row of solar modules.

11. The mounting system of claim 1, wherein the module clamps provide an electrical bond path between adjacent solar modules within a row of solar modules.

12. The mounting system of claim 1, wherein a structural clamp has a foot that abuts a roof surface.

13. The mounting system of claim 1, wherein one or more of the roof attachments in one or more of the first row, the second row, and the third row have a sealing layer disposed on at least a portion of an underside surface.

14. The method of claim 13, wherein the sealing layer is configured to create a watertight seal to the roof surface when the roof attachments are installed to the roof surface.

15. The mounting system of claim 1, wherein the roof surface is metal.

16. A method for installing mounting system for solar modules, the method comprising:
installing a first row of one or more roof attachments to a roof surface using a first set of fasteners;
installing a second row of one or more roof attachments to the roof surface using a second set of fasteners, the second row of roof attachments positioned up-roof from the first row of roof attachments at a distance less than an up-roof length of a yet-to-be-installed first row of solar modules; and
installing a third row of one or more roof attachments to a roof surface using a third set of fasteners, the third row of roof attachments positioned up-roof from a second row of roof attachments at a distance equal to the up-roof length of a yet-to-be-installed second row of solar modules plus or minus 10 inches.

17. The method of claim 16, wherein the roof attachments are configured to receive one or more module clamps for securing a solar energy module.

18. The method of claim 16, wherein the roof attachments have a sealing layer disposed on all or a portion of an underside surface.

19. The method of claim 18, wherein the sealing layer is configured to create a watertight seal to a roof surface when the roof attachment is installed to the roof surface.

20. The method of claim 16, wherein the roof attachment is configured to span between two or more ribs on a roof surface.

21. The method of claim 16, wherein the roof fasteners for attaching a roof attachment to a roof surface are configured to threadably pierce and mechanically engage a roof surface.

22. The method of claim 16, wherein the first row of solar modules are attached to the first row of root attachments and the second row of roof attachments using a plurality of module clamps, and the second row of solar modules are attached to the third row of roof attachments using a plurality of module clamps; and the first row of solar modules and the second row of solar modules are attached together using a plurality of structural clamps.

23. The method of claim 19, wherein the structural clamps provide an electrical bond path from a first row of solar modules to a second row of solar modules.

24. The method of claim 19, wherein the structural clamps have a foot that extends down to abut a roof surface.

25. The method of claim 13, wherein the roof surface is metal.
